(19) United States
(12) Patent Application Publication
(10) Pub. No.: US 2023/0085502 A1
(43) Pub. Date: Mar. 16, 2023

(54) MONITORING CIRCUITRY INCLUDING LEVEL SHIFTERS AND ANALOG PASS GATES

(71) Applicant: Hewlett-Packard Development Company, L.P., Spring, TX (US)

(72) Inventors: Eric T. Martin, Corvallis, OR (US); Rogelio Cicili, San Diego, CA (US)

(73) Assignee: Hewlett-Packard Development Company, L.P., Spring, TX (US)

(21) Appl. No.: 17/799,707

(22) PCT Filed: Mar. 6, 2020
(86) PCT No.: PCT/US2020/021511

§ 371 Date: Aug. 15, 2022

(51) Int. Cl. B41J 2/045

(52) U.S. Cl. CPC B41J 2/0451; B41J 2/04543; B41J 2/04546; B41J 2/0458

(57) ABSTRACT

According to examples, an apparatus may include fluid chambers that each includes a fluid actuator and an electrode. The fluid actuators may operate at a first voltage level and a monitoring circuitry may operate at a second voltage level that is lower than the first voltage level. The monitoring circuitry may monitor a condition of each fluid chamber based on a selection signal for selecting an electrode associated with a fluid chamber. The monitoring circuitry including an analog multiplexer that includes, for each of the electrodes for the plurality of fluid chambers, a level shifter to receive the selection signal at the second voltage level and to shift a level of the selection signal. The analog multiplexer may also include an analog pass gate to selectively couple the electrode of a respective fluid chamber to the monitoring circuitry based on the level shifted selection signal.

### BACKGROUND

Fluidic dies may include an array of nozzles and/or pumps, each including a fluid chamber and a fluid actuator, where a fluid actuator may be actuated to cause displacement of fluid within the fluid chamber. Some example fluidic dies may be printheads, where the fluid may correspond to printing fluid.

### BRIEF DESCRIPTION OF DRAWINGS

Features of the present disclosure are illustrated by way of example and not limited in the following figure(s), in which like numerals indicate like elements, in which:

FIG. 1 depicts a block and schematic diagram of an example apparatus including monitoring circuitry for electrodes for a plurality of fluid chambers;

FIG. 2 depicts a block and schematic diagram of an example apparatus in which monitoring circuitry includes sense circuitry and an analog multiplexer with connections to electrodes corresponding to a plurality of fluid chambers;

FIG. 3 depicts a block diagram of an analog multiplexer which may be implemented in the apparatus depicted in FIGS. 1 and 2, the analog multiplexer includes a level shifter and an analog pass gate for selecting a corresponding electrode associated with a fluid chamber among a plurality of fluid chambers;

FIG. 4 depicts a schematic diagram of an example level shifter, which may be implemented in the example analog multiplexer depicted in FIGS. 1-3; and

FIGS. 5A and 5B, respectively, depict schematic diagrams of example analog pass gates, which may be implemented in the example analog multiplexer depicted in FIGS. 1-3.

### DETAILED DESCRIPTION

For simplicity and illustrative purposes, the principles of the present disclosure are described by referring mainly to examples thereof. In the following description, numerous specific details are set forth in order to provide an understanding of the examples. It will be apparent, however, to one of ordinary skill in the art, that the examples may be practiced without limitation to these specific details. In some instances, well known methods and/or structures have not been described in detail so as not to unnecessarily obscure the description of the examples. Furthermore, the examples may be used together in various combinations.

Throughout the present disclosure, the terms “a” and “an” are intended to denote one of a particular element or multiple ones of a particular element. As used herein, the term “includes” means includes but not limited to, the term “including” means including but not limited to. The term “based on” may mean based in part on.

In some example designs (e.g., including inkjet or additive printer designs), sensors may sense the presence of drive bubbles in fluidic chambers used to propel droplets of printing fluid onto paper or other print target (e.g., an additive build material). Fluidic dies may include an array of nozzles and/or pumps each including a fluid chamber and a fluid actuator. Examples of fluidic dies may include fluid actuators. The fluid actuators may include thermal resistor-based actuators, piezoelectric membrane based actuators, electrostatic membrane actuators, mechanical/impact driven membrane actuators, magneto-strictive drive actuators, or other suitable devices that may cause displacement of fluid in response to electrical actuation. Fluidic dies described herein may include a plurality of fluid actuators, which may be referred to as an array of fluid actuators. An actuation event or firing event, as used herein, may refer to singular or concurrent actuation of fluid actuators of the fluidic die to cause fluid displacement.

In example fluidic dies, the array of fluid actuators may be arranged in sets of fluid actuators, where each such set of fluid actuators may be referred to as a “primitive” or a “firing primitive.” The number of fluid actuators in a primitive may be referred to as a size of the primitive. The set of fluid actuators of a primitive generally have a set of actuation addresses with each fluid actuator corresponding to a different actuation address of the set of actuation addresses. In some examples, electrical and fluidic constraints of a fluidic die may limit which fluid actuators of each primitive may be actuated concurrently for a given actuation event. Primitives facilitate addressing and subsequent actuation of fluid actuator subsets that may be concurrently actuated for a given actuation event to conform to such constraints.

To illustrate by way of example, if a fluidic die includes four primitives, with each primitive including eight fluid actuators (with each fluid actuator corresponding to different one of the addresses 0 to 7), and where electrical and fluidic constraints limit actuation to one fluid actuator per primitive, a total of four fluid actuators (one from each primitive) may be concurrently actuated for a given actuation event. For example, for a first actuation event, the respective fluid actuator of each primitive corresponding to address “0” may be actuated. For a second actuation event, the respective fluid actuator of each primitive corresponding to address “5” may be actuated. As will be appreciated, the example is provided merely for illustration purposes, such that fluidic dies contemplated herein may include more or fewer fluid actuators per primitive and more or fewer primitives per die.

Example fluidic dies may include fluid chambers, orifices, and/or other features which may be defined by surfaces fabricated in a substrate of the fluidic die by etching, microfabrication (e.g., photolithography), micromachining processes, or other suitable processes or combinations thereof. Some example substrates may include silicon based substrates, glass based substrates, gallium arsenide based substrates, and/or other such suitable types of substrates for microfabricated devices and structures. As used herein, fluid chambers may include ejection chambers in fluidic communication with nozzle orifices from which fluid may be ejected, and fluidic channels through which fluid may be conveyed. In some examples, fluidic channels may be microfluidic channels where, as used herein, a microfluidic channel may correspond to a channel of sufficiently small size (e.g., of nanometer sized scale, micrometer sized scale, millimeter sized scale, etc.) to facilitate conveyance of small volumes of fluid (e.g., picoliter scale, nanoliter scale, microliter scale, milliliter scale, etc.).

In some examples, a fluid actuator may be arranged as part of a nozzle where, in addition to the fluid actuator, the nozzle includes an ejection chamber in fluidic communication with a nozzle orifice. The fluid actuator may be positioned relative to the fluid chamber such that actuation of the fluid actuator causes displacement of fluid within the fluid chamber that may cause ejection of a fluid drop from the fluid chamber via the nozzle orifice. Accordingly, a fluid actuator arranged as part of a nozzle may sometimes be referred to as a fluid ejector or an ejecting actuator.

In some example nozzles, the fluid actuator may include a thermal actuator which is spaced from the fluid chamber by an insulating layer, where actuation (sometimes referred to as “firing”) of the fluid actuator heats the fluid to form a gaseous drive bubble within the fluid chamber that may cause a fluid drop to be ejected from the nozzle orifice, after which the drive bubble collapses. In some examples, a cavitation plate is disposed within the fluid chamber so as to be above the fluid actuator and in contact with the fluid within the chamber, where the cavitation plate protects material underlying the fluid chamber, including the underlying insulating material and fluid actuator, from cavitation forces resulting from generation and collapse of the drive bubble. In examples, the cavitation plate may be metal (e.g., tantalum).

In some examples, a fluid actuator may be arranged as part of a pump where, in addition to the fluidic actuator, the pump includes a fluidic channel. The fluidic actuator is positioned relative to a fluidic channel such that actuation of the fluid actuator generates fluid displacement in the fluid channel (e.g., a microfluidic channel) to convey fluid within the fluidic die, such as between a fluid supply (e.g., fluid slot) and a nozzle, for instance. A fluid actuator arranged to convey fluid within a fluidic channel may sometimes be referred to as a non-ejecting actuator. In some examples, similar to that described above with respect to a nozzle, a metal cavitation plate may be disposed within the fluidic channel above the fluid actuator to protect the fluidic actuator and underlying materials from cavitation forces resulting from generation and collapse of drive bubbles within the fluidic channel.

Fluidic dies may include an array of fluid actuators (such as columns of fluid actuators), where the fluid actuators of the array may be arranged as fluid ejectors (i.e., having corresponding fluid ejection chambers with nozzle orifices) and/or pumps (having corresponding fluid channels), with selective operation of fluid ejectors causing fluid drop ejection and selective operation of pumps causing fluid displacement within the fluidic die. In some examples, the array of fluid actuators may be arranged into primitives.

During operation of a fluidic die, conditions may arise that may adversely affect the ability of the nozzles to properly eject fluid drops and pumps to properly convey fluid within the die. For example, a blockage may occur in a nozzle orifice, ejection chamber, or fluidic channel, fluid (or components thereof) may become solidified on surfaces within a fluid chamber, such as on a cavitation plate, or a fluid actuator may not be functioning properly.

To determine when such conditions are present, techniques have been developed to measure various operating parameters (e.g., impedance, resistance, current, and/or voltage) of nozzles and pumps using a sense electrode which is disposed so as to be exposed to an interior of the fluid chamber. In one case, in addition to protecting fluid actuators and other elements from cavitation forces, cavitation plates may also serve as such sense electrodes. In some examples, the sense electrode may be used to measure an impedance of fluid within the chamber, where such impedance may be correlated to a temperature of the fluid, fluid composition, particle concentration, and a presence of air, among others, for instance.

Drive bubble detect (DBD) is one technique which measures parameters indicative of the formation and collapse of a drive bubble within a fluid chamber to determine whether a nozzle or pump is operating properly. In some examples, for a given fluid chamber, during an actuation event, a high-voltage (e.g., 30 V) is applied to the corresponding fluid actuator to vaporize a component of a fluid (e.g., water) to form a drive bubble within the fluid chamber. In some examples, at a selected time after commencement of the firing event (e.g., after the start of formation but before collapse of the drive bubble), low-voltage (e.g., 5 V) DBD monitoring circuitry of the fluidic die may selectively couple to the cavitation plate (or electrode) within the fluid chamber. In some examples, the DBD monitoring circuitry may provide a current pulse to the electrically conductive cavitation plate which flows through an impedance path formed by fluid and/or gaseous material of the drive bubble within the ejection chamber to a reference point (e.g., ground). The low-voltage DBD circuit may measure a resulting voltage on the cavitation plate, with the voltage being indicative of properties of the resulting drive bubble. The properties of the drive bubble may be used to infer the operating condition of the nozzle or pump (e.g., the nozzle/pump is operating properly, a nozzle orifice is plugged, etc.).

In example monitoring circuitry arrangements, including DBD monitoring circuitry, the cavitation plate (or other electrode within the fluid chamber) may be connected to a sense node, where portions of the monitoring circuitry may selectively couple to the cavitation plate by selectively coupling to the sense node. In some examples, the DBD monitoring circuitry may include an analog multiplexer which is controlled to selectively couple to the sense node during a sense operation. The analog multiplexer may include a controllable pass gate (e.g., nFETs, pFETs, etc.) enabled to selectively couple to the sense node during the sense operation, but which are otherwise disabled so as to be disconnected therefrom.

In some examples, the monitoring circuitry, including the controllable switch, may operate at a low voltage level (e.g., 3.3V to 5 V) relative to a high voltage level (e.g., 15 V to 32 V) at which fluid actuators operate. Monitoring circuitry may be disconnected from sense nodes by design. However, although the monitoring circuitry may be disconnected from the sense nodes while a high voltage is being applied to fluid actuators during firing events, the monitoring circuitry may nonetheless be exposed to and damaged by overvoltage conditions even when disconnected from a sense node if a fluid actuator short-circuits to a cavitation plate such that the high operating voltage of the fluid actuator is applied to the sense node. Because monitoring circuitry is typically implemented to minimize an amount of silicon area on a fluidic die, damage from such a fault voltage may not be limited to those portions of the monitoring circuitry associated with the faulted cavitation plate, but, due to the compact implementation, may cascade to other portions of the monitoring circuit. As a result, damage caused by a fluid actuator short circuit may prevent the ability of monitoring circuitry to monitor the nozzle or pump in which the short circuit occurred, and may also prevent the monitoring circuitry from monitoring other nozzles and/or pumps as well (such as all nozzles and pumps of a primitive, for example). In some cases, damage may cascade to portions of the fluidic die beyond the monitoring circuitry and may render the fluidic die inoperable.

Additionally, in some examples, monitoring circuitry may use CMOS devices operating at a high logic supply voltage, e.g., around 5V. However, more modern CMOS processes may operate at a lower logic supply voltage, e.g., around 3.3V. The present disclosure may include an analog multiplexer for a plurality of electrodes (e.g., cavitation plates) that may operate at the lower logic supply voltage, such that, for instance, existing monitoring circuitry may be transitioned to the newer CMOS processes. Particularly, the analog multiplexer of the present disclosure may include a level shifter together with an analog pass gate, in which the level shifter may raise a level of a selection signal operating at a lower logic supply voltage, e.g., 3.3V, to a higher level (e.g., 5V). A voltage regulator may, for instance, generate a reference voltage used to level shift the selection signal to the desired level.

Furthermore, in some examples, an implementation of the analog pass gate may include a high-voltage (HV) tolerant transistor that may have a back body diode that may cause unwanted leakage current to flow through the HV tolerant transistor, corrupting the measurement on other sensors. As such, the analog pass gate of the present disclosure may include a second transistor coupled in series to the HV tolerant transistor to prevent the leakage current through the HV tolerant transistor.

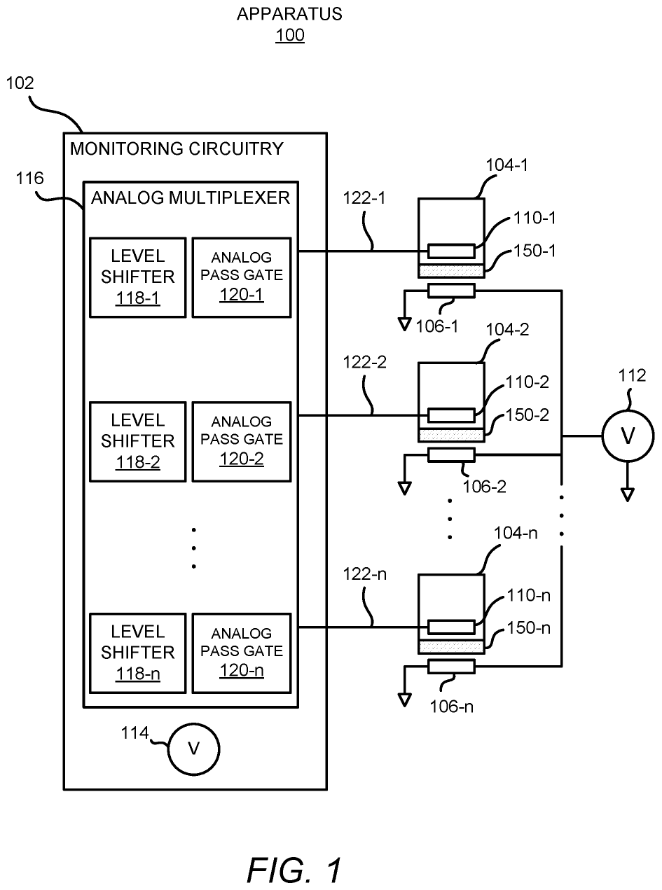

Reference is first made to FIG. 1, which depicts a block and schematic diagram of an example apparatus 100 including monitoring circuitry 102 for electrodes 110 for a plurality of fluid chambers 104. The apparatus 100, according to some examples of the present disclosure, may be a fluidic die having the plurality of fluid chambers 104 (illustrated as fluid chambers 104-1 to 104-n), each of the plurality of fluid chambers 104 including a fluid actuator 106 (illustrated as fluid actuators 106-1 to 106-n) and an electrode 110 (illustrated as electrodes 110-1 to 110-n) exposed to an interior of the fluid chamber 104. Each of the fluid actuators 106-1 to 106-n may be electrically and/or physically separated from a corresponding fluid chamber 104-1 to 104-n and electrode 110-1 to 110-n, such as by an insulating material 150 (illustrated as insulating material 150-1 to 150-n), which may be an oxide layer. Each of the fluid actuators 106 may operate at a high voltage 112 (e.g., a first voltage level). In some examples, each of the fluid actuators 106-1 to 106-n may be selectively coupled to a different high voltage source (e.g., a power FET). In one case, each electrode 110 may be a cavitation plate in a respective fluid chamber 104.

In accordance with examples of the present disclosure, the apparatus 100 may include monitoring circuitry 102 that may operate at a low voltage 114 relative to the fluid actuator 106 (e.g., a second voltage level) for monitoring operating conditions of each fluid chamber 104 via the corresponding sense electrode 110. In some examples, the low-voltage monitoring circuitry 102 may be DBD monitoring circuitry.

In some examples, for each fluid chamber 104, the monitoring circuitry 102 may include an analog multiplexer 116 to selectively connect to a respective electrode 110 via a connection 122 (illustrated as connections 122-1 to 122-n) (e.g., a sense node) during a sensing operation. The analog multiplexer 116 may include a plurality of level shifters 118 (illustrated as level shifters 118-1 to 118-n) and analog pass gates 120 (illustrated as analog pass gates 120-1 to 120-n).

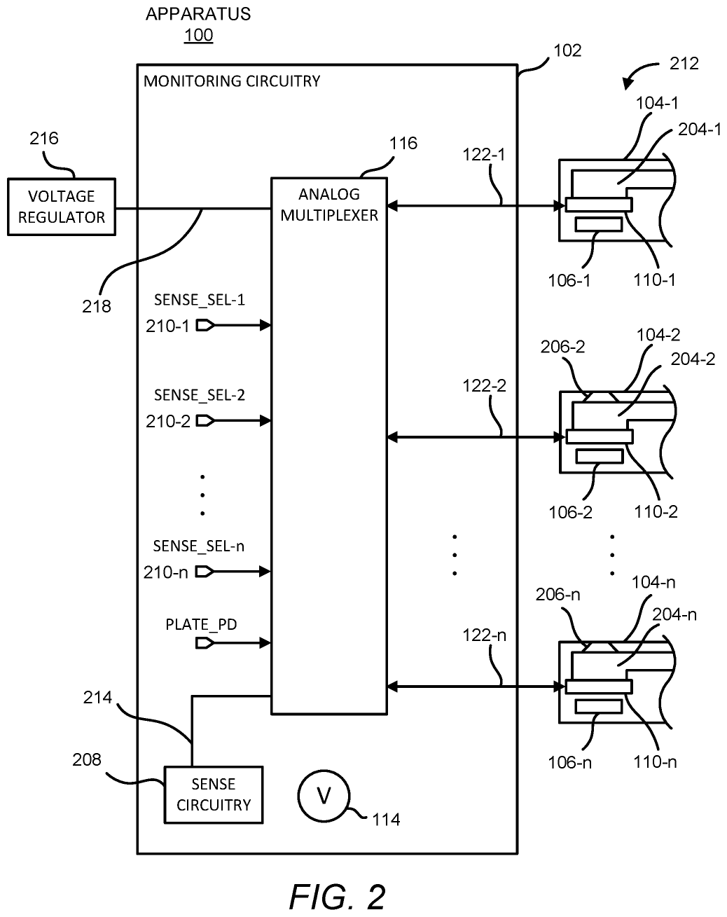

FIG. 2 depicts a block and schematic diagram of the example apparatus 100 in which the monitoring circuitry 102 includes sense circuitry 208 and an analog multiplexer 116 that connects to electrodes 110-1 to 110-n corresponding to a plurality of fluid chambers 104-1 to 104-n.

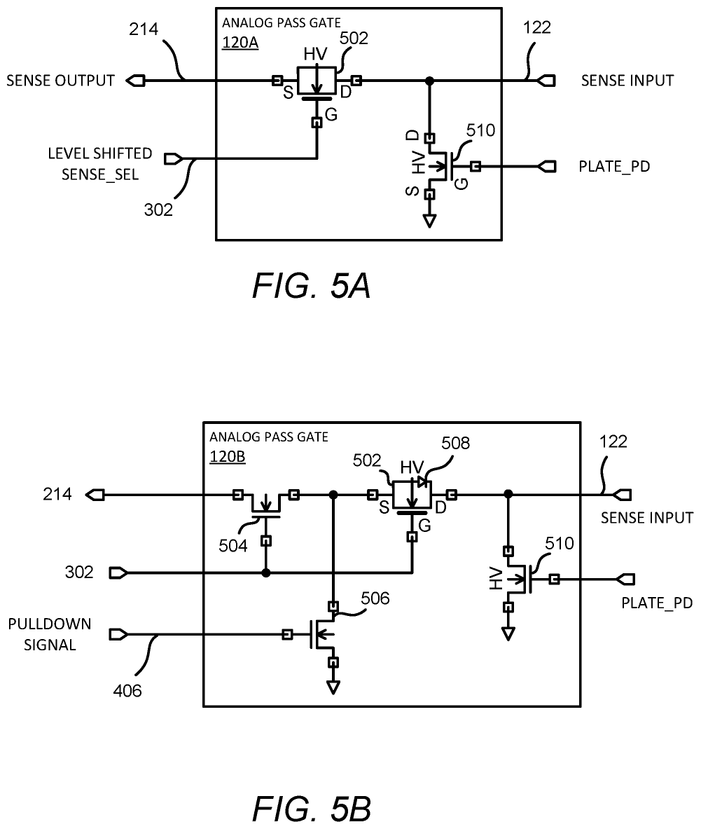

In some examples, the analog multiplexer 116 may include high voltage (HV) tolerant transistors (e.g., as illustrated in FIG. 5 as 502 and 510) which are exposed to the low voltage 114 of the monitoring circuitry 102 under normal operating conditions. The HV tolerant transistors may, however, be tolerant to a breakdown voltage level (e.g., a drain-to-source voltage, Vds) greater than the high voltage 112 of the fluid actuators 106. As discussed herein, the HV tolerant transistors may prevent the occurrence of a fault current flowing into the analog multiplexer 116 from an electrode 110 under a fault condition responsive to the corresponding fluid actuator 106 short-circuiting to the electrode 110.

Although a low-voltage rated device (which is smaller and less costly than a high-voltage tolerant device) may be suitable for use as a transistor in the low-voltage monitoring circuitry, employing an HV tolerant transistor may prevent a fault current from flowing into the selected transistor from an electrode 110 if the fluid actuator 106 short-circuits to the electrode 110. As such, the HV tolerant transistor may prevent damage to the analog multiplexer 116 connected to the electrode 110 as well as prevent damage potentially to other portions of the monitoring circuitry 102 and may eliminate a need for a dedicated fault protection device. In other examples, as will be described in greater detail herein, in addition to the analog multiplexer 116 including a HV tolerant device, the pulldown transistor 510 (FIG. 5) may also be an HV tolerant device.

In some examples, the apparatus 100 may be a fluidic die including a plurality of fluid chambers 104, with each fluid chamber 104 having an electrode 110 exposed to an interior thereof. In some examples, the electrode 110 may be a cavitation plate disposed at a bottom of a fluid chamber 104. Each fluid chamber 104 may have a corresponding fluid actuator 106 which is separated from the fluid chamber 104 and electrode 110, such as by the insulating material 150. In some examples, fluid actuators 106 may operate at a first voltage (e.g., a high voltage 112, such as 15 V and up to 32 volts, for instance) and, when actuated, may cause vaporization of a fluid 204 (e.g., ink, illustrated as fluid 204-1 to 204-n) within a fluid chamber 104 to form a drive bubble therein. In the case of a nozzle, where the fluid chamber 104 is in fluidic communication with a nozzle orifice 206 (illustrated as nozzle orifices 206-2 to 206-n), formation of a drive bubble via actuation of the fluid actuator 106 may cause ejection of a fluid drop (e.g., ink) from the fluid chamber 104 via the nozzle orifice 206. In a case where the fluid chamber 104 is a pump (e.g., without a nozzle orifice), formation of a drive bubble by actuation of fluid actuator 106 may cause conveyance of fluid within the fluidic die (e.g., to/from a nozzle).

In some examples, the apparatus 100 may include the monitoring circuitry 102 for monitoring operating conditions of each fluid chamber 104 of the plurality of fluid chambers, where the monitoring circuitry 102 operates at a second voltage (e.g., a low voltage 114 relative to the fluid actuator 106, such as 3.3 V, for instance), where the low voltage 114 of the monitoring circuit 102 is lower than the high voltage 112 at which the fluid actuators 106 operate. In one case, the monitoring circuitry 102 may include DBD monitoring circuitry. According to some examples, the monitoring circuitry 102 may include the analog multiplexer 116 that, during a sensing operation, operate to selectively connect to a corresponding electrode 110 (e.g., cavitation plate) via a connection 122 (illustrated as connections 122-1 to 122-n), with each connection 122 electrically connected to the corresponding electrode 110.

In some examples, a portion of the fluid actuators 106 may be arranged as part of a nozzle where the corresponding fluid chamber 104 is in fluidic communication with a nozzle orifice 206 (such as illustrated by fluid chambers 104-2 and 104-n, for instance), and another portion may be arranged as part of a pump (such illustrated by fluid chamber 104-1 without a nozzle orifice, for instance). In some examples, each cavitation plate (e.g., electrode 110) may be disposed within the corresponding fluid chamber 104 so as to be exposed to an interior thereof and which may be in contact with fluid 204 if present therein (e.g., ink).

In some example arrangements, the monitoring circuitry 102 may include sense circuitry 208, where the analog multiplexer 116 may couple to the sense circuitry 208. The monitoring circuitry 102 may further include a sense select signal 210 (Sense_Sel) (illustrated as sense select signals Sense_Sel-1 to Sense_Sel-n), and a plate pulldown signal (Plate_PD) to the analog multiplexer 116 (e.g., to the gate (G) of each pulldown FET 510 as depicted in FIG. 5).

According to examples, during firing events of fluid actuators 106 (e.g., to eject fluid via nozzles and convey fluid within fluidic die via pumps), monitoring circuitry 102, via the Plate_PD, may maintain pulldown FETs 510 in an enabled state (e.g., an on state) to maintain the electrodes 110 at a “safe” voltage (e.g., ground), and may isolate the sense circuitry 208 from the electrodes 110. Additionally, during a sensing operation, such as described below, pulldown FETs 510 may ensure that a connection 122 is at a known initial reference voltage before enabling the analog multiplexer 116 to connect to an electrode 110 and starting a sense measurement.

During a sensing operation (e.g., a DBD sense operation), according to some examples, monitoring circuitry 102 may monitor one selected fluid chamber 104 of primitive 212 at a given time. In some examples, during a sensing operation, the sense circuitry 208 may connect to the electrode 110 of the selected fluid chamber 104 by enabling the corresponding analog pass gate 120 in the analog multiplexer 116 via the Sense_Sel signal 210. In one case, after connecting to the electrode 110 via the analog multiplexer 116 to the selected electrode 110, the sense circuitry 208 may disable the corresponding pulldown FET 510 to disconnect the electrode 110 from the reference voltage (e.g., ground). In some examples, the sense circuitry 208, via the electrode 110, may provide a sense current (e.g., a current pulse) through a portion of the fluid chamber 104 to a reference point (e.g., ground), including, in some examples, through fluid 204 and/or vaporized portions thereof within the selected fluid chamber 104.

The sense circuitry 208 may monitor a resulting voltage on the node at the connection 122 to evaluate an operating condition of the selected electrode 110 for a fluid chamber 104. The analog multiplexer 116 may be connected to the sense circuitry 208, and may be implemented to relay the voltage on the node at the connection 122. The analog multiplexer 116 may include a sense output 214 that is coupled to the sense circuitry 208 to relay a signal associated with the operating condition of the selected fluid chamber 104.

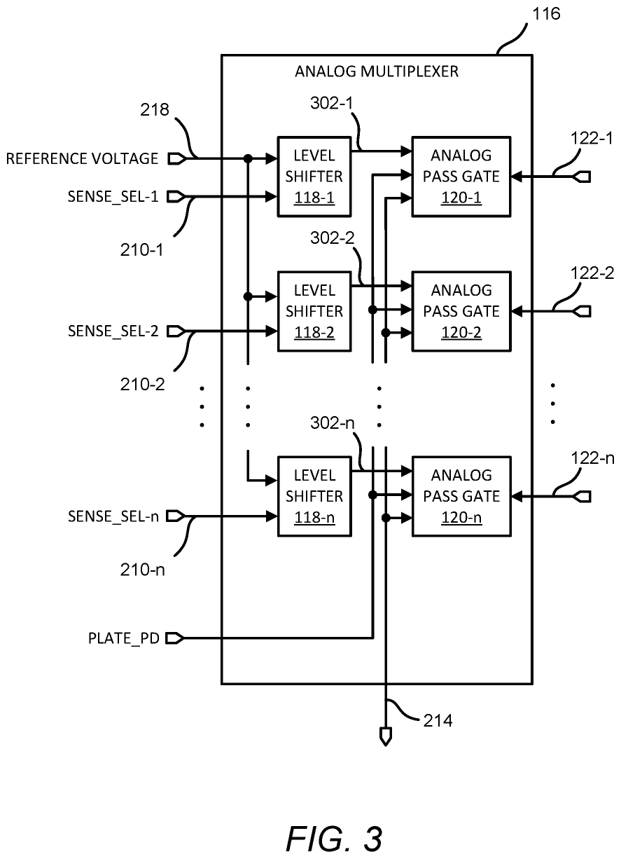

In some examples, a voltage regulator 216 may be connected to the analog multiplexer 116 connected to each of the electrodes 110. The voltage regulator 216 may output a reference voltage 218 (FIG. 3) to the analog multiplexer 116 to enable the level shifters 118 to increase a voltage level (e.g., level shift) of the Sense_Sel signal 210 to a desired level, as will be described in more detail below.

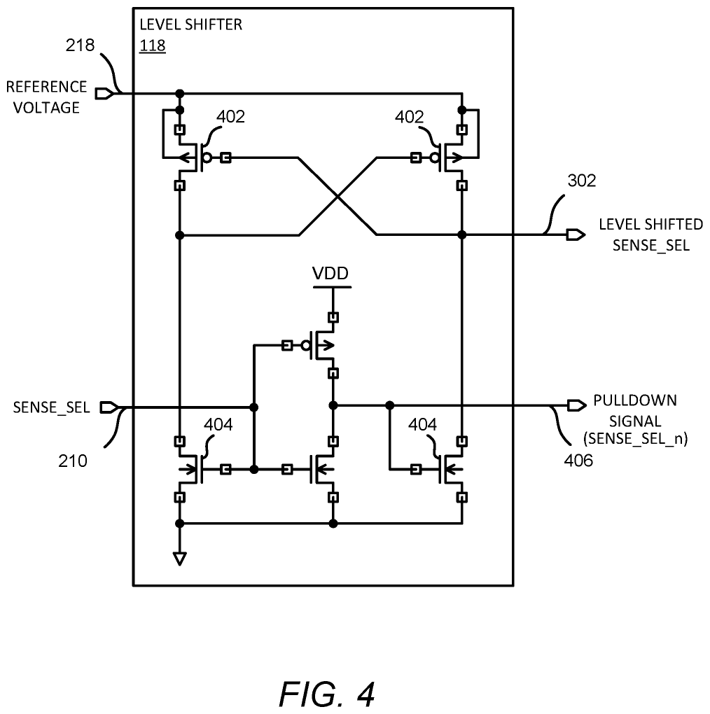

Reference is now made to FIGS. 3-5. FIG. 3 depicts a block diagram of an analog multiplexer 116, which may be implemented in the apparatus 100 depicted in FIGS. 1 and 2, the analog multiplexer 116 including a level shifter 118 and an analog pass gate 120 for selecting a corresponding electrode 110 associated with a fluid chamber 104 among a plurality of fluid chambers. FIG. 4 depicts a block and schematic diagram of an example level shifter 118, which may be implemented in the example analog multiplexer 116 depicted in FIGS. 1-3. FIGS. 5A and 5B, respectively, depict block and schematic diagrams of example analog pass gates 120A and 120B which may be implemented in the example analog multiplexer 116 depicted in FIGS. 1-3.

In some instances, the analog multiplexer 116 may include CMOS devices operating at a higher logic supply voltage, e.g., about 5V. However, more modern CMOS processes may operate at a lower logic supply voltage, e.g., about 3.3V (e.g., low voltage 114). In order to transition to the newer CMOS processes at the lower logic supply voltage, the monitoring circuitry 102 may be implemented to operate at the lower logic supply voltage while level shifting certain signals to be compatible with the higher logic supply voltage associated with some devices.

Referring to FIG. 3, the analog multiplexer 116 may include a level shifter 118 together with an analog pass gate 120. The analog multiplexer 116 may receive a selection signal (e.g., Sense_Sel-1 signal 210-1). The Sense_Sel signal 210 may be at the low voltage 114 (e.g., 3.3 V). The level shifter 118 may also receive the reference voltage 218 from the voltage regulator 216. The level shifter 118 may use the reference voltage 218 to shift the level of the Sense_Sel signal 210 to generate a level shifted selection signal 302. The analog pass gate 120 may selectively couple an electrode 110 of a respective fluid chamber 104 to the sense circuitry 208 based on the level shifted selection signal 302 received from the level shifter 118.

By way of particular example, the level shifter 118 may raise the level of the input Sense_Sel signal 210 from 3.3V of the operating voltage 114 to a higher, level shifted voltage of 4.2 V based on the reference voltage 218. The voltage level of the level shifted Sense_Sel signal 302 may be set to a value associated with the HV tolerant transistor included in the analog pass gate 120 or a value associated with the voltage range of the sense circuitry 208.

Referring to FIG. 4, the level shifter 118 may receive from the voltage regulator 216 the reference voltage 218 used to level shift the Sense_Sel signal 210. The level shifter 118 may generate the level shifted Sense_Sel signal 302 using the reference voltage 218. The level shifter 118 may include a MOSFET 402, 404 (e.g., NMOS, PMOS) or the like. It should be appreciated that various types of digital level shifter designs may be used. The level shifted Sense_Sel signal 302 may be a level shifted version of the Sense_Sel signal 210. By way of particular example, the level shifted Sense_Sel signal 302 may be level shifted from 3.3. V to 4.2 V. The level shifter 118 may also generate a pulldown signal 406 (e.g., Sense_Sel_n signal), which may be a complement of the Sense_Sel signal 210. The pulldown signal 406 may be used to control the pulldown transistor 506 (FIG. 5B), as described in detail below.

Referring to FIG. 5A, the analog pass gate 120 may include an HV tolerant device 502. The HV tolerant device 502 may be an NMOS FET that is tolerant of relatively high voltage levels at Vgd (gate to drain voltage) and Vds (drain to source voltage) (e.g., 32 V) associated with the operation of the fluid actuator 106 at the high voltage 112. The HV tolerant device 502 may be coupled to the electrode 110 via a node at connection 122. By way of particular example, the gate (G) may be coupled to the level shifted Sense_Sel signal 302, the drain (D) may be coupled to the electrode 110 via the node at connection 122, and the source (S) may be coupled to the sense output 214 that is connected to the sense circuitry 208.

In some examples, the pulldown transistors 510 may include LV rated devices having a breakdown voltage less than an operating voltage of the fluid actuators 106. In other examples as depicted in FIGS. 5A and 5B, in addition to the analog pass gates 120 including HV tolerant devices 502, the pulldown transistors 510 may be HV tolerant devices.

In some examples, each analog pass gate 120 may have a pulldown transistor 510 (or pulldown switch) and may include a MOS FET (e.g., NMOS, PMOS) having a gate (G), a source region (S), and a drain region (D), with the drain region (D) being connected to the corresponding node at a connection 122. In other examples, the source regions (S) of the pulldown transistors 510 may be coupled to a respective connection 122 in lieu of the drain regions (D). In some examples, as illustrated, the pulldown transistor 510 may be an HV tolerant device having a drain region (D) with a breakdown voltage which is greater than the high voltage 112 at which the fluid actuator 106 operates.

In some examples, the pulldown transistor 510 may be coupled to the node at connection 122, and together with the HV tolerant device 502, may protect the analog multiplexer 116. The pulldown transistor 510 may also be implemented to initialize a voltage at the node at connection 122 before performing a DBD measurement. According to examples, under normal operating conditions, the pulldown transistors 510 may be exposed to and may operate at the low voltage 114 of monitoring circuitry 102, such as 3.3 volts, for instance. Although operating at the low voltage 114 of the monitoring circuitry 102, in some examples, certain transistors employed in the analog multiplexer 116 may include HV tolerant transistors, in which the one of the source (S) and drain (D) regions connected to the connection 122 have a breakdown voltage (e.g., Vds, a voltage at which a normally non-conducting pn-junction between the one of the source/drain regions and a substrate breaks down and becomes conductive) which is greater than the high voltage 112 at which the fluid actuator 106 of the corresponding fluid chamber 104 operate. In some examples, the breakdown voltage Vdg between the drain (D) and the source (S) may be high voltage tolerant.

By way of particular example, the HV tolerant device 502 and/or the pulldown transistor 510 may enable the analog multiplexer 116 to tolerate voltage levels at the first voltage level (e.g., high voltage 112) to prevent a fault current from flowing into the monitoring circuitry 102 from the electrode 110 in a fault condition responsive to the corresponding fluid actuator 106 short-circuiting to the electrode 110. The pulldown transistor 510 may be controlled by the Plate_PD signal to the gate of the pulldown transistor 510. In some examples, the pulldown transistor 510 may initialize the voltage on connection 122 and electrode 110 before performing a DBD measurement.

The level shifted Sense_Sel signal 302 may be coupled to the gate (G) of the HV tolerant device 502. The increased level of the level shifted Sense_Sel signal 302 may cause the HV tolerant device 502 to operate in a proper range to pass signals from the electrode 110 at desired voltage levels. Based on the level shifted Sense_Sel signal 302, the HV tolerant device 502 may pass signals at the sense output 214 to the sense circuitry 208.

Referring to FIG. 5B, in some examples, the analog pass gate 120B may include an HV tolerant device 502 including a back body diode 508 coupled across a source (S) and a drain (D) of the high voltage tolerant device 502. The back body diode 508 may be an intrinsic characteristic of the transistor that is created during fabrication of the HV tolerant device 502. In some instances, the back body diode 508 may cause unwanted leakage current to flow through the HV tolerant transistor 502, corrupting the measurement on sensors for other electrodes 110-n, such as when a voltage at the sense output 214 is greater than a voltage at connection 122, which may forward bias the back body diode 508.

In this instance, the analog pass gate 120B may include a second transistor 504 coupled in series to the high voltage tolerant device 502 to provide isolation from the back body diode 508. The second transistor 504 may be a LV rated device (e.g., a standard NMOS device), or alternatively, the second transistor 504 may be a HV tolerant device. The second transistor 504 may be coupled in series to the HV tolerant device 502, such that a source (S) of the second transistor is 504 is coupled to the drain (D) of the high voltage tolerant device 502 at a first node and a drain (D) of the second transistor 504 is coupled to a third node at the sense output 214 (e.g., at the sense circuitry 208). It should be appreciated that other configurations may be possible. The gate (G) of the second transistor 504 and the gate of the high voltage tolerant device 502 may be coupled to the level shifted selection signal (e.g., level shifted Sense_Sel 302) at a second node.

In some examples, the analog pass gate 120B may include a third transistor 506 coupled between the first node and a ground to pull down the first node to the ground based on a pulldown signal 406. The pulldown signal 406 may be a logical complement of the Sense_Sel signal 210 that is output from the level shifter 118, as previously described with reference to FIG. 4. According to examples, during firing events of fluid actuators 106 (e.g., to eject fluid via nozzles and convey fluid within fluidic die via pumps), monitoring circuitry 102, via the pulldown signal 406, may maintain the third transistor 506 in an enabled state (e.g., a closed position) to maintain an electrode 110 at a “safe” voltage (e.g., ground), and may isolate sense circuitry 208 from the electrodes 110. Additionally, during a sensing operation, the third transistor 506 may ensure that the source (S) of the HV tolerant device 502 is at a known initial reference voltage (e.g., ground) before enabling the analog multiplexer 116 to connect to electrode 110 and starting a sense measurement.

By way of particular example, the apparatus 100 may include a fluidic die including a plurality of fluid chambers 104, each of the plurality of fluid chambers 104 including an electrode 110 exposed to an interior of the fluid chamber 104 and having a corresponding fluid actuator 106, the fluid actuators 106 to operate at a first voltage level (e.g., high voltage 112). The fluidic die may also include monitoring circuitry 102 to operate at a second voltage level (e.g., low voltage 114) lower than the first voltage level and to monitor a condition of each fluid chamber 104 of the plurality of fluid chambers 104 (e.g., by monitoring a condition or state of an electrode, which is related to a condition or state of a bubble formed in ink within a fluid chamber 104) based on a selection signal 210 for selecting an electrode 110 for a fluid chamber 104 among the plurality of fluid chambers 104. The monitoring circuitry 102 may include an analog multiplexer 116, and the analog multiplexer 116 may include level shifters 118 and analog pass gates 120 associated with each of the plurality of electrodes 110.

The level shifter 118 may receive the selection signal 210 at the second voltage level and shift a level of the selection signal 210 to a level shifted selection signal 302. The analog multiplexer 116 may selectively couple the electrode 110 of a respective fluid chamber 104 to the monitoring circuitry 102 based on the level shifted selection signal 302. In some examples, the analog pass gates 120 may have a high voltage tolerant device 502 (e.g., HV tolerant transistor) coupled to the electrode 110 and a second transistor 504 coupled in series between the high voltage tolerant device 502. In this instance, the monitoring circuitry 102 may pass a signal from the electrode 110 to the monitoring circuitry 102.

The high voltage tolerant device 502 is to operate at the first voltage level in a normal operating condition, the high voltage tolerant device 502 having a breakdown voltage level greater than the first voltage level to prevent a fault current from flowing into the monitoring circuitry 102 from the electrode 110 in a fault condition responsive to the fluid actuator 106 short-circuiting to the electrode 110. In some examples, the analog pass gate 120 may include a third transistor 506 coupled to a first node between the high voltage tolerant device 502 and the second transistor 504, the third transistor 506 to pull down the first node to a reference voltage, e.g., a ground.

By way of particular example, an apparatus 100 may include a plurality of fluid chambers 104, each of the plurality of fluid chambers 104 including an electrode 110 exposed to an interior of the fluid chamber 104 and having a corresponding fluid actuator 106, the fluid actuators 106 to operate at a first voltage level (e.g., a high voltage 112). The apparatus 100 may include monitoring circuitry 102 to operate at a second voltage level (e.g., a low voltage 114) lower than the first voltage level and to monitor a condition of each electrode 110 for the plurality of fluid chambers 104 based on a selection signal (e.g., a Sense_Sel signal 210) for selecting an electrode 110 among a plurality of electrodes 110 associated with the plurality of fluid chambers 104. In this instance, the monitoring circuitry 102 may include sense circuitry 208 to sense signals from the electrodes 110 of each of the plurality of fluid chambers 104. In some examples, the monitoring circuitry 102 may include a voltage regulator 216 to generate a reference voltage 218 at a third voltage level that is greater than the second voltage level and less than the first voltage level.

In this instance, the monitoring circuitry 102 may include an analog multiplexer 116, each of the analog pass gates 120 being for a respective electrode 110 for a fluid chamber 104 of the plurality of fluid chambers 104. In this case, a level shifter 118 may select the analog pass gate 120 to receive the selection signal for the selected electrode 110 at the second voltage level and to shift a level of the selection signal based on the reference voltage to generate a level shifted selection signal (e.g., a level shifted Sense_Sel signal 302), and an analog pass gate 120 to selectively couple the electrode 110 of the selected fluid chamber 104 to the monitoring circuitry 102 based on the level shifted selection signal.

In some examples, the analog pass gate 120 may include a high voltage tolerant transistor (e.g., a HV tolerant device 502) to operate at the first voltage level in a normal operating condition and has a breakdown voltage level greater than the first voltage level to prevent a fault current from flowing into the monitoring circuitry 102 from the electrode 110 in a fault condition responsive to the corresponding fluid actuator 106 short-circuiting to the electrode 110.

The high voltage tolerant transistor may include a back body diode (e.g., back body diode 508) coupled across a source and a drain of the high voltage tolerant transistor. The analog pass gate 120 may include a second transistor 504 coupled in series between the high voltage tolerant transistor and the monitoring circuitry 102 to pass a signal from the electrode 110 through the analog multiplexer 116. The analog pass gate 120 may include a third transistor 506 coupled to a first node between the high voltage tolerant transistor and the second transistor 504, the third transistor to pull down the first node to a reference voltage, e.g., a ground.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a plurality of fluid chambers, each of the plurality of fluid chambers including an electrode and a corresponding fluid actuator, each of the electrodes being exposed to an interior of a corresponding fluid chamber and each of the fluid actuators to operate at a first voltage level; and
monitoring circuitry to operate at a second voltage level that is lower than the first voltage level and to monitor a condition of each fluid chamber of the plurality of fluid chambers based on a selection signal for selecting an electrode associated with a fluid chamber among the plurality of fluid chambers, the monitoring circuitry including an analog multiplexer that includes for each of the electrodes for the plurality of fluid chambers:
a level shifter to receive the selection signal at the second voltage level and to shift a level of the selection signal; and
an analog pass gate to selectively couple the electrode of a respective fluid chamber to the monitoring circuitry based on the level shifted selection signal.

2. The apparatus of claim 1, wherein the analog pass gate includes a high voltage tolerant transistor, the high voltage tolerant transistor to tolerate voltage levels at the first voltage level in a normal operating condition and to tolerate a breakdown voltage level that is greater than the first voltage level to prevent a fault current from flowing into the monitoring circuitry from the electrode in a fault condition responsive to a corresponding fluid actuator short-circuiting to the electrode.

3. The apparatus of claim 2, wherein the high voltage tolerant transistor includes a back body diode coupled across a source and a drain of the high voltage tolerant transistor, and the analog pass gate includes a second transistor coupled in series to the high voltage tolerant transistor.

4. The apparatus of claim 3, wherein
a source of the second transistor is coupled to the drain of the high voltage tolerant transistor at a first node and a drain of the second transistor is coupled to a third node at a sense circuitry, and
a gate of the second transistor and a gate of the high voltage tolerant transistor are coupled to the level shifted selection signal at a second node.

5. The apparatus of claim 4, wherein the analog pass gate includes a third transistor coupled between the first node and a ground to pull down the first node to the ground based on a pulldown signal.

6. The apparatus of claim 1, wherein the monitoring circuitry further comprises:
a voltage regulator coupled to the analog multiplexer, the analog multiplexer being connected to each of the electrodes associated with the plurality of fluid chambers, the voltage regulator to provide a reference voltage that is greater than the second voltage level of the selection signal.

7. The apparatus of claim 6, wherein the level shifter is to increase the level of the selection signal from the second voltage level to a third voltage level based on the reference voltage, the third voltage level being greater than the second voltage level and less than the first voltage level.

8. The apparatus of claim 1, wherein the analog pass gate includes a pulldown transistor for each of the electrodes, the pulldown transistor for an electrode comprising a high voltage tolerant transistor and a source of the pulldown transistor being coupled between the electrode and the analog pass gate and a drain of the pulldown transistor being coupled to a ground.

9. A fluidic die comprising:
a plurality of fluid chambers, each of the plurality of fluid chambers including an electrode and a corresponding fluid actuator, each of the electrodes being exposed to an interior of a respective fluid chamber and each of the fluid actuators to operate at a first voltage level; and
monitoring circuitry to operate at a second voltage level that is lower than the first voltage level and to monitor a condition of each fluid chamber of the plurality of fluid chambers based on a selection signal for selecting an electrode associated with a fluid chamber among the plurality of fluid chambers, the monitoring circuitry including an analog multiplexer that includes for each of the electrodes for the plurality of fluid chambers:
a level shifter to receive the selection signal at the second voltage level and to shift a level of the selection signal; and
an analog pass gate to selectively couple the electrode of a respective fluid chamber to the monitoring circuitry based on the level shifted selection signal, the analog pass gate having a high voltage tolerant transistor coupled to the electrode and a second transistor coupled in series between the high voltage tolerant transistor and the monitoring circuitry to pass a signal from the electrode to the monitoring circuitry.

10. The fluidic die of claim 9, wherein the high voltage tolerant transistor is to tolerate voltage levels at the first voltage level in a normal operating condition and to tolerate a breakdown voltage level that is greater than the first voltage level to prevent a fault current from flowing into the monitoring circuitry from the electrode in a fault condition responsive to the corresponding fluid actuator short-circuiting to the electrode.

11. The fluidic die of claim 9, wherein the analog pass gate includes a third transistor coupled to a first node between the high voltage tolerant transistor and the second transistor, wherein the third transistor is to pull down the first node to a ground.

12. An apparatus comprising:
a plurality of fluid chambers, each of the plurality of fluid chambers including an electrode and a corresponding fluid actuator, each of the electrodes being exposed to an interior of a respective fluid chamber and each of the fluid actuators to operate at a first voltage level; and
monitoring circuitry to operate at a second voltage level that is lower than the first voltage level and to monitor a condition of each fluid chamber of the plurality of fluid chambers based on a selection signal for selecting an electrode associated with a fluid chamber among the plurality of fluid chambers, the monitoring circuitry including:
sense circuitry to sense signals from the electrodes of each of the plurality of fluid chambers;
a voltage regulator to generate a reference voltage at a third voltage level greater than the second voltage level and less than the first voltage level; and
an analog multiplexer that includes for each of the electrodes for the plurality of fluid chambers:
a level shifter to receive the selection signal at the second voltage level and to shift a level of the selection signal based on the reference voltage to generate a level shifted selection signal; and
an analog pass gate to selectively couple the electrode of the selected fluid chamber to the monitoring circuitry based on the level shifted selection signal.

13. The apparatus of claim 12, wherein the analog pass gate includes a high voltage tolerant transistor that is tolerant to the first voltage level in a normal operating condition and that is tolerant to a breakdown voltage level that is greater than the first voltage level to prevent a fault current from flowing into the monitoring circuitry from the electrode in a fault condition responsive to the corresponding fluid actuator short-circuiting to the electrode.

14. The apparatus of claim 13, wherein the high voltage tolerant transistor includes a back body diode coupled across a source and a drain of the high voltage tolerant transistor, and wherein the analog pass gate includes a second transistor coupled in series between the high voltage tolerant transistor and the monitoring circuitry to pass a signal from the electrode to the sense circuitry.

15. The apparatus of claim 14, wherein the analog pass gate includes a third transistor coupled to a first node between the high voltage tolerant transistor and the second transistor, wherein the third transistor is to pull down the first node to a ground.
